(19) United States
(12) Patent Application Publication
(10) Pub. No.: US 2003/0065509 A1
(43) Pub. Date: Apr. 3, 2003

(54) Method for improving noise reduction in speech transmission in communication systems

(75) Inventor: Michael Walker, Lichtenwald (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/191,483

(22) Filed: Jul. 10, 2002

(30) Foreign Application Priority Data
Jul. 13, 2001 (DE) 10134146.6

(51) Int. Cl. G10L 21/02

(52) U.S. Cl. 704/228

(57) ABSTRACT

Noise reduction measures must be taken in order to ensure a natural speech transmission in a noise-filled environment. This is particularly necessary in the case of speech-controlled appliances, in which speech recognition is an important quality feature. So-called spectral subtraction is used, as is known, for the purpose of noise reduction. In order to improve the determination of the noise components of a noisy speech signal using a Wiener filter, the conditions for calculation of the transmission function H(n) of the Wiener filter are adapted, according to the invention, to the nonlinear transmission behaviour of the human ear. For this purpose, in combination with the specified conditions, a Continuous Fourier Transformation is advantageously performed which prevents the occurrence of so-called musical tones. Despite a large noise reduction, loss of quality in the speech transmission is prevented by the method.

The invention is based on a priority application DE 101 34 146.6 which is hereby incorporated by reference.

### BACKGROUND OF THE INVENTION

Where a speech signal is overlaid with unwanted noise it is essential to use methods for noise reduction. In the use of mobile telephones, unwanted noises are, for example, street noise, flight noise or noise in sports stadia. In order to ensure a natural speech transmission from a noise-filled environment, it is necessary to take measures to reduce the noise in the speech transmission. There is also an increasing use of speech-controlled appliances in which speech recognition is an important quality feature and which is essentially dependent on the mastery of noise reduction. The same problem must be resolved in the case of coding, for converting speech into text.

DE 69 420 705 describes a system for noise suppression which comprises a multiplicity of microphones, signal processing means and an adaptive filter, which is preferably a Wiener filter. Auto and cross power spectra are determined from frequency-transformed sampling values of the speech signals. The signal processing means are provided in order to determine combined auto and cross power spectra from the auto and cross power spectra. The combined auto and cross power spectra provide the coefficients for the adaptive filter.

DE 696 06 978 describes a method for noise suppression by means of spectral subtraction. In that case, non-speech frames are estimated using a non-parametric power spectrum estimation method, all N sampling values of each frame being used. A stationary background noise is assumed over several frames and a reduction of the variance of the power spectrum estimated value is achieved through averaging of the power spectrum estimated value over several non-speech frames. Speech frames are estimated using a parametric power spectrum estimation method, on the basis of a parametric model. Each speech frame contains a predefined number N of audio sampling values, as a result of which N degrees of freedom are assigned to each speech frame. The variance of the power spectrum estimation is reduced in that the parametric model contains few parameters, the parametric model reducing the number N of the degrees of freedom to the number of the parameters of the parametric model.

A generally known method for noise reduction is that of so-called spectral subtraction. In this method, the noisy speech signal is first transformed from the time domain into the frequency domain, for example, by means of the Fast Fourier Transformation FFT, the noise spectrum is then determined in the speech pauses and subtracted from the frequency spectrum of the noisy speech signal before the noisy speech signal is reconverted from the from the frequency domain into the time domain by means of the Inverse Fast Fourier Transformation IFFT. The result depends essentially on the accuracy of the determination of the noise spectrum. Although good results are achieved in the case of stationary noise, in practice noises are not stationary and the achievable results are therefore unsatisfactory.

Methods for spectral subtractions are described, for example, in the publications “Improved Spectral Subtraction for Speech Enhancement”, Y. Malca, D. Wulich, and “Extended Spectral Subtraction”, P. Sovka, P. Pollak, J. Kubie; EUSIPCO '96 Proceedings, Trieste, 10-13 September '96. These publications also make reference to fundamental works relating to spectral subtraction.

The frequently used FFT has the disadvantage that, due to the block-wise processing of the signals in the time domain, a compromise has to be found between the resolution in the time domain and the resolution in the frequency domain.

The frequency of a frequency line is determined according to Equation 1.

$$f ( n ) = \frac{Fs}{N} \cdot n \qquad ( 1 )$$

The frequency spacing of the FFT is constant and is obtained from Equation 2.

$$df = \frac{Fs}{N} \qquad ( 2 )$$

For Fs=8 kHz and N=256,

$$df = \frac{8 kHz}{256} = 31.25 Hz$$

df frequency spacing

f frequency

n number of the frequency line

Fs sampling frequency

N number of frequency lines

With a shorter block, for example N=128, although a better time resolution is obtained, a poorer resolution is nevertheless obtained in the frequency domain with df=62.5 Hz. The linear frequency resolution of the FFT thus does not take account of essential psychoacoustic characteristics. By contrast, the frequency resolution of the human ear is nonlinear. The transmission function is described more fully in Eberhard Zwicker: Phychoakustik, Springer Verlag, Berlin, Heidelberg, New York, 1982, pages 20-30. The time resolution of the human ear is approximately 1.9 ms, but that of a 256 point FFT, for example, is 32 ms. Due to these differences between the FFT and the psychoacoustic requirements, a natural-effect speech transmission can be achieved only with limitations in respect of quality. In addition, the additional signal delay due to the block-wise signal processing impairs a telecommunication device both by disrupting the natural flow of a conversation and through the increased echo perception.

The practice of using a Wiener filter for determining the noise components of a noisy speech signal is generally known. A Wiener filter is described in, for example, “Numerical Recipes in G: The Art of Scientific Computing”; chapter 13.3, Optimal (Wiener) Filtering with the FFT; pages 547-549, Cambridge University Press 1988-1992. With the Wiener filter, the magnitude of the transmission function |H(n)| is calculated for each frequency n, according to Equation 3.

$$\vert H ( n ) \vert = \{ \begin{matrix}1 - o \cdot {( \frac{E ( n )}{\vert X ( n ) \vert} )}^{2} & if \vert X ( n ) \vert > E ( n ) \\ NFL & otherwise\end{matrix} \qquad ( 3 )$$

|H(n)| magnitude of the transmission function for the frequency n

E(n) estimated averaged value for the ambient noise

|X(n)| magnitude of the noisy speech

NFL background noise, noise floor

o overestimation factor

The mean value of the noise is calculated using a first-order recursive filter during the speech pauses. The filter coefficients used are constant.

According to Equation 3, |H(n)|=1 if E(n)=0, i.e., when there is no noise. If E(n)≠0, so that the difference becomes less than 1, then, in the ideal case, the noise is subtracted from the spectrum of the noisy speech signal without affecting the speech signal. If, for a frequency n, the power density of the estimated noise E(n) becomes greater than the power density of the estimated noisy speech signal, the above relationship in Equation 3 would produce a negative value. In this case, |H(n)| is set =NFL, so that a background noise NFL is permitted in order to prevent an unnatural masking-out of all noises. The overestimation factor o provided for in Equation 3 serves to reduce errors in the estimation of the energy contents.

Due to the block-wise processing of the signals by means of the FFT, in the inverse transformation using the IFFT one value is obtained per block, so that a discontinuous value sequence can result which is audible as so-called “musical tones” in the reconverted speech signal. In order to prevent this effect, a sufficiently large value of the background noise NFL is selected to mask the “musical tones”. This, however, has the result that only a very limited noise reduction, of approximately 6 dB, can be achieved with the described algorithm and, particularly in the case of a very small speech-to-noise ratio, an improvement is not possible, for example, greater than 10 dB.

### SUMMARY OF THE INVENTION

There thus ensues, from the described disadvantages of the noise reduction method using a Wiener filter, the object of altering the noise estimation by means of the Wiener filter and the rules for transforming the noisy speech signals from the time domain into the frequency domain and vice versa so as to permit an adaptation to the nonlinear transmission behaviour of the human ear.

This object is achieved by the method disclosed in the first claim.

The essence of the invention consists in that the conditions for determining the transmission function of the Wiener filter are optimized and that a Continuous Fourier Transformation is used as a rule for transforming the noisy speech signal. The Continuous Fourier Transformation is described in the patent application DE 10 111 249.1.

The application of the Continuous Fourier Transformation creates new conditions for an improved noise reduction.

The application of the rule, described in connection with Equation 3, for the transmission function |H(n)| of the Wiener filter of the prior art has the result that, in the case of small speech signals, |H(n)| becomes =NFL and, consequently, speech syllables with a low energy content are omitted from the output signal. The sum of the speech signal and noise |X(n)| is a highly modulated signal which exceeds the noise level E(n) only temporarily, when the energy of the corresponding frequency of the speech signal is just in the transition to the energy content of the noise threshold value. This effect occurs particularly when the noise is modulated and superimposed on the speech signal.

In order to achieve a greater sensitivity for small speech signal-to-noise ratios, the changeover of the transmission function |H(n)| to the background noise NFL is only permitted, according to the invention, if the estimated mean value of the speech signal SE(n) is not greater than the estimated mean value of the noise E(n), see Equation 4.

$$\vert H ( n ) \vert = \{ \begin{matrix}1 - o \cdot {( \frac{E ( n )}{\vert X ( n ) \vert} )}^{2} & if \vert X ( n ) \vert > E ( n ) \\ NFL & if \overline{SE ( n )} > \overline{E ( n )}\end{matrix} \qquad ( 4 )$$

Due to this rule, even faint components of the speech signal are reliably transmitted, and the system is thus better adapted to the speech spectrum.

A first-order recursive filter permits determination of the estimated mean values of the Speech signal SE(n) and of the noise E(n). The speech signal SE(n) is estimated during the speech activity, pause indicator p=0, and the noise E(n) is estimated during the speech pauses, pause indicator p=1, according to Equations 5 and 6.

$$\begin{matrix}SE ( n , k ) = \{ \begin{matrix}α ( n ) \cdot \vert X ( n , k ) \vert + β ( n ) \cdot SE ( n , k - 1 ) & if p = 0 \\ SE ( n , k - 1 ) & otherwise\end{matrix} & ( 5 ) \\ E ( n , k ) = \{ \begin{matrix}α ( n ) \cdot \vert X ( n , k ) \vert + β ( n ) \cdot E ( n , k - 1 ) & if p = 1 \\ E ( n , k - 1 ) & otherwise\end{matrix} & ( 6 )\end{matrix}$$

k sampling instant

p pause indicator

α, β filter coefficients, which can assume fixed values or be frequency-dependent

The values SE(n) and E(n) determined according to Equations 5 and 6 are calculated in dependence on frequency and produce an optimum time response.

In order to prevent disturbing transient noise fluctuations, Equation 3 is expanded in such a way that the difference is only formed if the speech signal SE(n) is greater than the noise E(n), see Equation 4. The time response of the speech signal SE(n) can then be determined according to the speech characteristics, which differ from short excitations of the noise E(n).

$$\vert H ( n ) \vert = \{ \begin{matrix}1 - o \cdot {( \frac{E ( n )}{\vert X ( n ) \vert} )}^{2} & if ( SE ( n ) > E ( n ) ) \& ( \vert X ( n ) \vert > E ( n ) ) \\ NFL & if \overline{SE ( n )} > \overline{E ( n )}\end{matrix} \qquad ( 4 )$$

The unwanted “musical tones” effect of the known noise reduction methods is eliminated if, instead of the transformation methods such as, for example FFT and IFFT, which work in blocks, transformation methods are used in which the nonlinear frequency resolution of the human ear is taken into account. Thus, a range of auditory characteristics, such as frequency resolution, time resolution and selection characteristics must be taken into account if a natural-sounding speech signal, or an audio signal generally, is to be received. In order to achieve this, a Fourier transformation has already been disclosed which is adapted to the transmission function of human sensory organs, cf. DE 101 11 249.1. This transformation deviates from the fixed assignment of number of frequencies N equal to number of sampling values K, which necessitate a constant frequency spacing according to Equation 1 and a constant bandwidth B, and a Continuous Fourier Transformation CFT and an Inverse Continuous Fourier Transformation ICFT of the speech are performed. In the case of the CFT, a time function x(k) is mapped in frequency groups, the number and magnitude of which are determined, for example, according to the BARK scale, cf. Kapust, Rolf: Qualitatsbeurteilung codierter Audiosignale mittels einer BARK-Transformation, Dissertation 1993, University of Erlangen-Nürnberg. Within a frequency group, a number of frequency lines N is calculated so that the frequency resolution and the time resolution are matched to the transmission function of the human ear. The bandwidth B(n) with which a frequency line is transmitted is determined from the frequency lines n+1 and n-1 adjacent to a frequency line n. From the bandwidth B(n) is determined the limiting frequency fg of a low-pass filter which, as an integrator, replaces the otherwise usual summation of the blocks and thus effects a sliding transformation. A rapid modification and, consequently, an adaptation to the current situation of the calculated transmission function |H(n)| is already achieved with 17 frequency lines, at a sampling rate of 8 kHz. This rapid modification results in a modulation of the reconverted speech. An improved time response of the transmission function |H(n)| is achieved if a frequency-dependent short average magnitude SAM (|H(n)|) of the transmission function is formed, and a noise-reduced frequency line n is thus produced. The short average magnitude SAM (|H(n)|) is formed using a recursive filter such as that described in, for example, EP 1 005 016 A2 and represented in FIG. 3 thereof.

The low-pass used as an integrator in the case of the Continuous Fourier Transformation CFT for the purpose of determining each frequency line can be further improved in the formation of the complex frequency, for the purpose of improving the speech quality in noise reduction systems. Since speech signals exist for a certain duration, for example, longer than 100 ms, and noises can nevertheless occur in shorter time intervals during the speech, it is useful to determine a real component and an imaginary component of the complex frequency according to Equations 8, 9 and 10. Equations 8 and 9 describe a first-order recursive low-pass filter.

re(n,k)=cos(n,k)·x(k)·ax(n)+re(n,k−1)·βx(n) (8)

im(n,k)=sin(n,k)·x(k)·ax(n)+im(n,k−1)·βx(n) (9)

the filter coefficients x(n) being determined according to the following Equation 10.

$$\begin{matrix}x ( n ) = \{ \begin{matrix}κ \cdot τ & if \vert re ( k ) - im ( k ) \vert > \vert re ( k - 1 ) - im ( k - 1 ) \vert \\ τ & otherwise\end{matrix} \\ τ = \frac{1}{2 \cdot π \cdot fb ( n )} fb = bandwidth of the frequency line \\ κ = 2 … 10 const .\end{matrix} \qquad ( 10 )$$

This modification has the effect that interruptions in the speech signal due to reduction of very large, short noises are restored. Due to the large time constant effected by the filter coefficient x(n), the current magnitude and the current phase position are maintained, so that speech interruptions are avoided.

If a large noise reduction is to be achieved, the background noise NFL assumes a very small value. This also results in the suppression of very weak speech signals, which may then be evaluated as noise. In order to prevent this effect, the background noise can be determined in dependence on the current requirements, according to Equation 11.

$$\begin{matrix}nfl ( n , k ) = \{ \begin{matrix}nava ( n ) \cdot NFL + navb ( n ) \cdot nfl ( n , k - 1 ) & if SE ( n ) > E ( n ) \\ {NFL}_{min} & otherwise\end{matrix} \\ nava ( n ) = 1 - navb ( n ) = 1 - {ⅇ}^{\frac{2 π fb ( n )}{Fs}}\end{matrix} \qquad ( 11 )$$

Fs=sampling frequency

Fb(n)=bandwidth of the frequency line n

nava noise floor average a

navb noise floor average b

Equation 11 is used to average a background noise nfl(n), which is dependent on the frequency, if the speech signal SE(n) is greater than the noise E(n). When speech is present, the value for the background nfl(n) is greater than the minimum background noise, so as to ensure that speech signals are not suppressed.

The overestimation factor o determines the magnitude of the noise reduction during the speech activity. A large noise reduction requires a small overestimation factor o. Experiments have shown that an optimum overestimation factor o can be determined according to Equation 12.

$$o ( n ) = \frac{1}{log ( nfl ( n ) )} \qquad ( 12 )$$

Taking into account the conditions, adapted to the nonlinear transmission behaviour of the human ear, for determining the transmission function (|H(n)|) of the Wiener filter, then

$$\vert H ( n ) \vert = S A M ( n ) \{ \begin{matrix} 1 = o ( n ) \cdot {( \frac{E ( n )}{\vert X ( n ) \vert} )}^{2} & i f ( S E ( n ) > E ( n ) ) \& ( \vert X ( n ) \vert > E ( n ) ) \\ nfl ( n ) & i f ( S E ( n ) > E ( n ) )\end{matrix} \qquad ( 13 )$$

With this rule, the nonlinear transmission behaviour of the human ear is taken into account. Despite a large noise reduction, loss of quality in the speech transmission is prevented by means of the method.

### BRIEF DESCRIPTION OF THE DRAWINGS

The invention is explained further with reference to an embodiment example and the associated drawing, wherein:

FIG. 1 shows a block diagram of a circuit arrangement for spectral subtraction using a Wiener filter according to the prior art,

FIG. 2 shows a block diagram of a circuit arrangement for spectral subtraction using a Wiener filter and application of a Continuous Fourier Transformation,

FIG. 3 shows a block diagram for the application of the Continuous Fourier Transformation for the purpose of reducing noise, and

FIG. 4 shows a distribution of the frequency lines to the frequency groups in the case of the Continuous Fourier Transformation.

### DESCRIPTION OF PREFERRED EMBODIMENTS

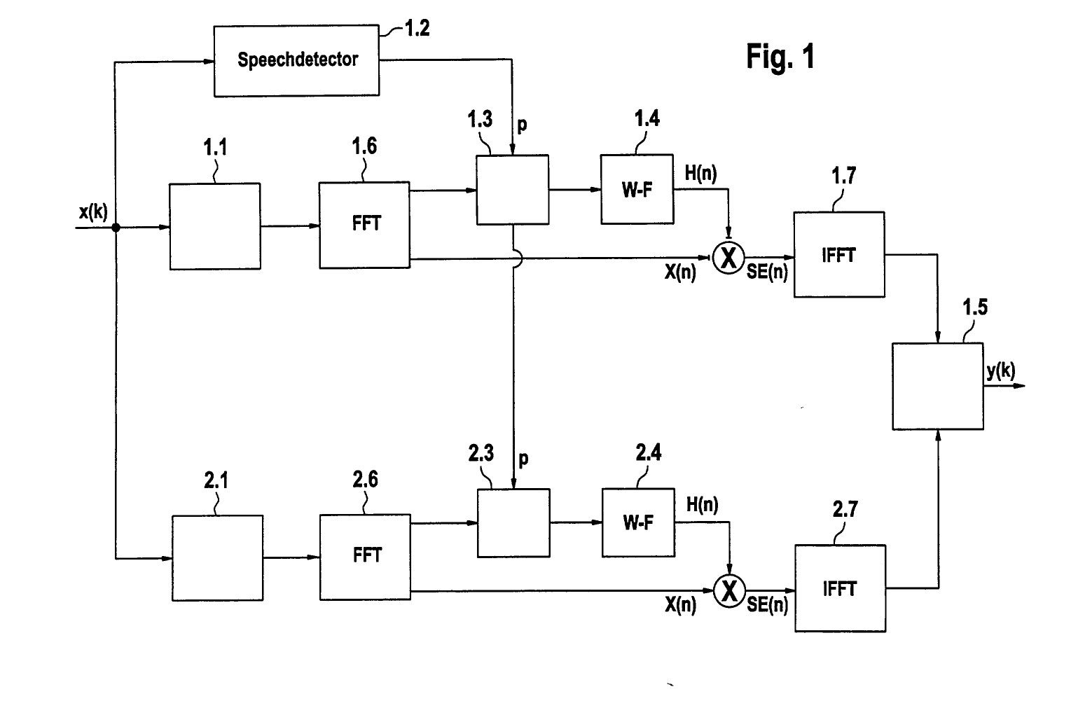

As shown by FIG. 1, a circuit arrangement for noise reduction consists essentially of two modules for windowing 1.1, 2.1 of the analog-digital converted input signal x(k), a speech detector 1.2, two noise averaging devices 1.3, 2.3, two Wiener filters 1.4, 2.4 and an overlap add 1.5, as well as the modules for the Fast Fourier Transformation FFT 1.6, 2.6 and for the Inverse Fast Fourier Transformation 1.7, 2.7. For the purpose of processing the input signal x(k) by means of the FFT, the input signal x(k) is divided into blocks, of the length N, also called windows, in such a way that the spectral characteristics are largely constant for the duration of the window. Whereas, in the middle of the window, the course of the function can be precisely described, the information on how the function continues is absent at the edge of the window. Two windows, offset by ½N, are therefore processed, for example, according to the Hamming function and, following back-transformation, overlapped by means of an overlap add 1.5 so that the energy values are not falsified at the edges of the windows. The noise averaging device 1.3, 2.3 is used to determine a mean value, in the speech pauses, from the input signal x(k) transformed into the frequency domain. The speech pause is ascertained by a speech detector 1.2 which delivers a signal p as a pause indicator, p=0 corresponding to speech, p=1 corresponding to speech pause. The power density of the noise spectrum H(n) is calculated using the Wiener filter 1.4, 2.4 and subtracted from the noisy speech signal X(n), so that the noise-corrected speech signal SE(n) can be transformed back out of the frequency domain into the time domain by means of the IFFT and, following overlapping of the windows, the speech signal y(k) is formed in the time domain.

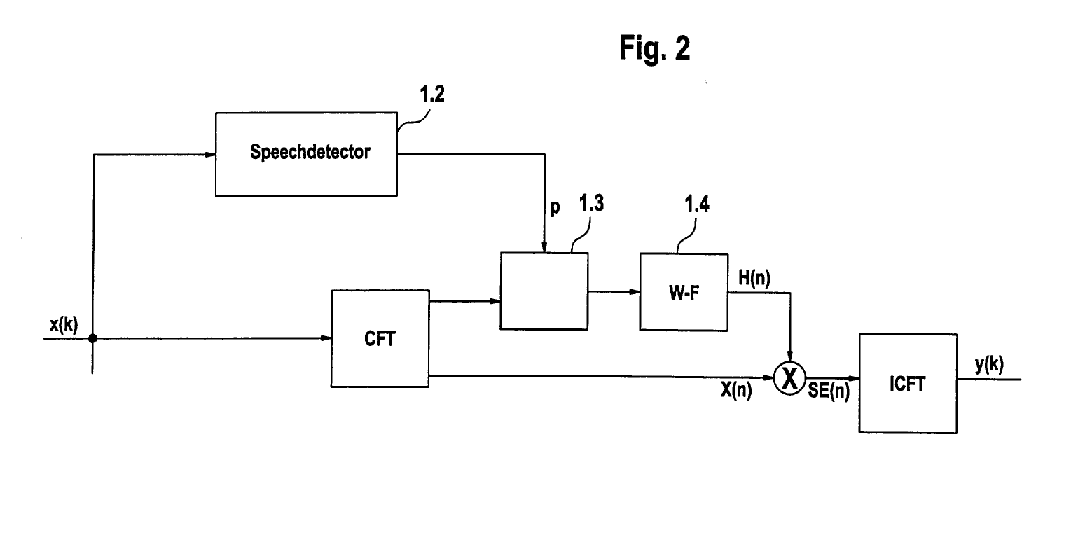

The disassociation from block processing in the FFT and IFFT renders windowing and window overlapping superfluous, as shown in FIG. 2. Otherwise, the method steps described in connection with FIG. 1 are also performed in the application of the Continuous Fourier Transformation CFT and the Inverse Continuous Fourier Transformation ICFT according to FIG. 2.

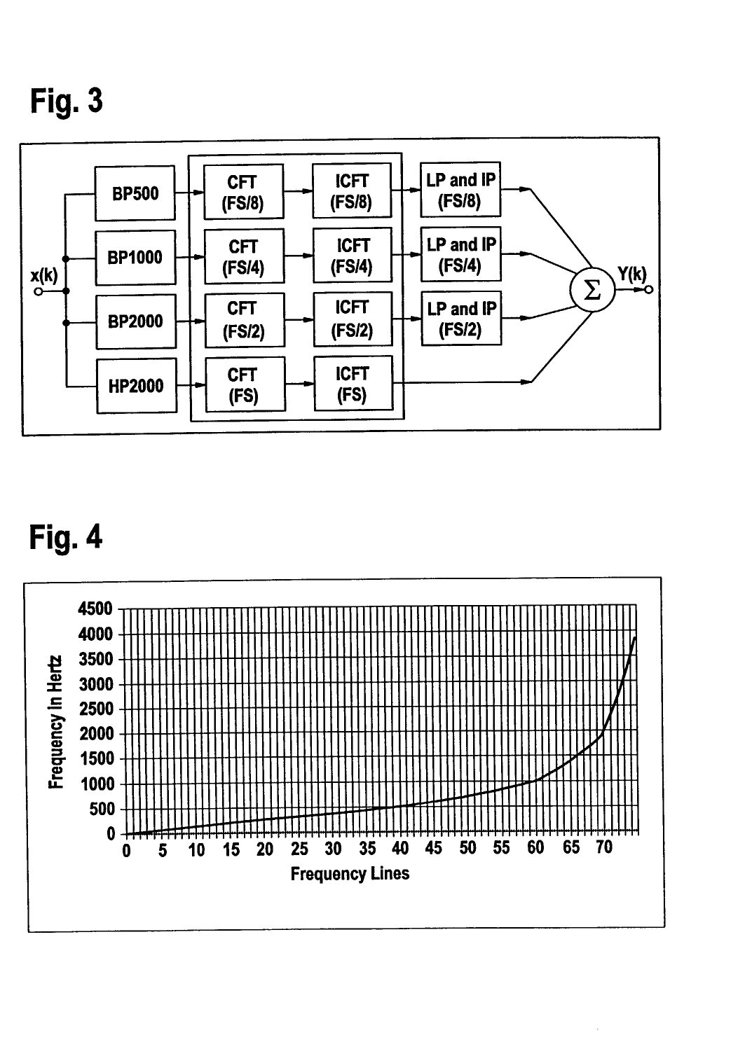

FIG. 3 shows an example for the application of the CFT/ICFT. The input signal x(k) is divided into four frequency groups, scaled logarithmically. This division is effected, for example, at a sampling frequency Fs=8 kHz, there being formed a first frequency group with a bandwidth B=500 Hz, at a first sampling frequency

$$\frac{1}{8} F s = 1000 Hz ,$$

a second frequency group with a bandwidth B=1000 Hz, at a second sampling frequency

$$\frac{1}{4} F s = 2000 Hz ,$$

a third frequency group with a bandwidth B=2000 Hz, at a third sampling frequency

$$\frac{1}{2} F s = 4000 Hz ,$$

and a fourth frequency group for frequencies over 2000 Hz, at the sampling frequency Fs=8 kHz. Via the bandpass filters BP 500, BP 1000 and BP 2000, and via the high-pass filter HP 2000, the input signal x(k) according to FIG. 3 is transformed by means of the CFT into the frequency domain, in which it is processed according to the application and transformed back into the time domain, as y(k), by means of the ICFT, via low-pass filters LP and interpolation filters IP and through summation of the frequency groups.

FIG. 4 shows the distribution of the frequency lines to the frequency groups, as is particularly advantageous, for example, in the case of an economically optimized version. This distribution is eminently suitable in the case of the application of noise reduction in the spectral domain. The first frequency group up to 500 Hz is allotted 40 frequency lines, the second frequency group up to 1000 Hz is allotted 20 frequency lines, the third frequency group up to 2000 Hz is allotted 10 frequency lines and the fourth frequency group up to 4000 Hz is allotted 5 frequency lines. In the noise reduction example illustrated, a high frequency resolution is desired in precisely that frequency range in which the majority of frequencies which are attributable to the interfering noise occur, i.e., practically, the range between f=0 and 2 kHz. As shown in FIG. 4, 75 frequency lines have been logarithmically distributed such that the frequency resolution in the lower frequency range up to 500 Hz is particularly high, in this case being 10 Hz. Such a frequency resolution is not even achieved with a FFT with 512 frequency lines, the frequency resolution in this case being 16 Hz. As shown by FIG. 4, the frequency resolution decreases, to the topmost frequency line, to 510 Hz, corresponding to a time resolution of 0.98 ms, whereas the FFT with 512 frequency lines has a constant value of 31.25 ms. The necessary computational requirement can be greatly reduced through subsampling with decimation filters and interpolation filters. The range with the most frequency lines can be subjected to the greatest subsampling. Experiments have shown that the above-mentioned 75 frequency lines per sampling value can be reduced to 20 frequency lines per sampling value without loss of quality of a natural-sounding speech.

1. Method for improving noise reduction in speech transmission by applying a rule for transforming a noisy speech signal in the time domain into a noisy signal in the frequency domain and using a Wiener filter with the transmission function
$$\vert H ( n ) \vert = \{ \begin{matrix} 1 - o \cdot {( \frac{E ( n )}{\vert X ( n ) \vert} )}^{2} & i f ( \vert X ( n ) \vert > E ( n ) ) \\ N F L & o t h e r w i s e\end{matrix}$$
for evaluating the noise spectrum for the purpose of performing a spectral subtraction of the noise spectrum from the frequency spectrum of the noisy speech signal,
wherein
for the transmission function H(n), the value of a background noise NFL is set if the estimated mean value of the speech signal is smaller than the estimated mean value of the noise,
in that for the transmission function H(n), a current value is calculated for a frequency if the mean value of the speech signal is greater than the estimated mean value of the noise and the magnitude of the noisy speech signal |X(n)| is greater than the estimated mean value of the noise and wherein, in application of a Continuous Fourier Transformation for the transformation of the noisy speech signal from the time domain into the frequency domain, a frequency-dependent short average magnitude is formed for the transmission function H(n).

2. Method according to claim 1, wherein the value of the background noise is calculated for a frequency in dependence on the noise reduction factor and in dependence on the probability with which this frequency occurs in the speech spectrum.

3. Method according to claim 1, wherein the value of an overestimation factor o is selected which is equal to the reciprocal value of the decimal logarithm from the noise reduction factor.
